(19) United States
(12) Patent Application Publication
(10) Pub. No.: US 2026/0023179 A1
(43) Pub. Date: Jan. 22, 2026

(54) METHOD AND APPARATUS FOR DISTINGUISHING OBJECTS USING ULTRASOUND FOR PARKING OF VEHICLE

(71) Applicants: Hyundai Motor Company, Seoul (KR); Kia Corporation, Seoul (KR)

(72) Inventors: Eun Seok Jung, Hwaseong (KR); Dong Hyuk Kim, Hwaseong (KR)

(21) Appl. No.: 18/971,629

(22) Filed: Dec. 6, 2024

(30) Foreign Application Priority Data
Jul. 18, 2024 (KR) 10-2024-0095073

(51) Int. Cl. G01S 15/931; G01B 17/02

(52) U.S. Cl. CPC G01S 15/931; G01B 17/02; G01S 2015/932

(57) ABSTRACT

A method for distinguishing objects to assist in parking a vehicle includes steps of: setting an ultrasonic sensor to a low-frequency mode or a high-frequency mode; sending a signal and receiving a received signal reflected from an object, by using the ultrasonic sensor; determining whether the received signal contains noise; distinguishing the object based on a height of the object by using the received signal; and determining whether the vehicle can be parked by using the height of the object. The above steps can be carried out by a controller in conjunction with the ultrasonic sensor.

### CROSS-REFERENCE TO RELATED APPLICATION

This application claims under 35 U.S.C. § 119 (a) the benefit of Korean Patent Application No. 10-2024-0095073, filed on Jul. 18, 2024, the entire contents of which are incorporated herein by reference.

### BACKGROUND

### (a) Technical Field

The present disclosure relates to a method and apparatus for distinguishing objects by using ultrasound, more particularly, to the method and apparatus for distinguishing objects based on a height of one or more of the objects by using ultrasound and for determining whether a vehicle can be parked.

### (b) Description of the Related Art

A variety of parking assistance features using autonomous driving technology are being developed. Among these features is a Remote Start Parking Assist (RSPA) feature. The RSPA feature helps the driver park and pull out the vehicle remotely from outside the vehicle, navigates a parking space with an ultrasonic sensor, and assists in steering, slowing down, and accelerating the vehicle.

The presence and location of an object can be detected by using an ultrasonic sensor. Incidentally, some part of ultrasound is reflected from a tall object, and another part of the ultrasound is reflected from a short object. One limitation of ultrasonic sensors is that they cannot distinguish between a tall object and a short object. For example, they cannot distinguish between a curb (a short object) and a vehicle (a tall object). Thus, if the driver tries to park the vehicle in a spot too small for it to fit in, they could potentially get their vehicle bumped. Therefore, a system is required that assists in parking by distinguishing between a tall object and a short object based on the height of the object.

### SUMMARY

In view of the above, the present disclosure provides a method and apparatus for assisting in parking a vehicle by distinguishing objects based on the height of the object.

The problems to be solved by the present disclosure are not limited to the above-mentioned ones, and other problems not mentioned herein may be clearly understood by those skilled in the art from the description below.

According to at least an aspect, the present disclosure provides a method for distinguishing objects, the method comprising: setting an ultrasonic sensor to a low-frequency mode or a high-frequency mode; sending a signal and receiving a signal reflected from an object, by using the ultrasonic sensor; determining whether the received signal contains noise; distinguishing the object based on the height of the object by using the received signal; and determining whether the vehicle can be parked by using height information of the object.

According to another aspect of the above-described method, a method for distinguishing objects to assist in parking a vehicle may include steps of: setting, by a controller, an ultrasonic sensor to a low-frequency mode or a high-frequency mode; sending, by an ultrasonic sensor, a signal and receiving a received signal that is reflected from an object; determining, by the controller, whether the received signal contains noise; distinguishing, by the controller, the object based on a height of the object by using the received signal; and determining, by the controller, whether the vehicle can be parked by using the height of the object.

According to another aspect, the present disclosure provides an apparatus for distinguishing objects, the apparatus comprising: at least one memory storing instructions; and at least one processor, wherein the at least one processor sets an ultrasonic sensor to a low-frequency mode or a high-frequency mode, sends a signal and receives a signal reflected from an object, by using the ultrasonic sensor, determines whether the received signal contains noise, distinguishes the object based on the height of the object by using the received signal, and determines whether the vehicle can be parked by using height information of the object.

A vehicle may include the apparatus for distinguishing objects.

According to a further aspect, the present disclosure provides a non-transitory computer-readable recording medium containing program instructions executed by a processor, the computer readable medium including: program instructions that send a signal and receive a received signal that is reflected from an object; program instructions that determine whether the received signal contains noise; program instructions that distinguish the object based on a height of the object by using the received signal; and program instructions that determine whether the vehicle can be parked by using the height of the object.

According to an embodiment of the present disclosure, it is possible to assist in parking by distinguishing objects based on the height of the object by using an ultrasonic sensor.

The effects of the present disclosure are not limited to the above-mentioned ones, and other effects not mentioned herein may be clearly understood by those skilled in the art from the description below.

### BRIEF DESCRIPTION OF THE DRAWINGS

FIG. 1 is a block diagram schematically showing an object distinguishing apparatus according to an embodiment of the present disclosure.

FIG. 2 is a view showing the sound pressure over time of signals transmitted to or from an ultrasonic sensor according to an embodiment of the present disclosure.

FIG. 3 is a flowchart schematically showing an operation of an object distinguishing apparatus according to an embodiment of the present disclosure.

FIG. 4 is a flowchart for illustrating an object distinguishing method according to an embodiment of the present disclosure.

FIG. 5 is a block diagram schematically showing an exemplary computing device that can be used to implement a method according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

The following detailed description, together with the accompanying drawings, is intended to illustrate exemplary embodiments of the present disclosure and is not intended to represent the only embodiments in which the disclosure may be practiced.

Hereinafter, the term “first type object” refers to an object type that is shorter than a reference height, and the term “second type object” refers to an object that is taller than the reference height. As used herein, the term “reference height” is configuration information that serves as a baseline for distinguishing the type of an object. Reference height may refer to, but not limited to, a height from a ground surface or a floor surface to the uppermost end of an object. Reference height may mean the height of an object based on which it is possible to distinguish whether the vehicle can be parked near or over the object. The first type object may include a curb, and the second type object may include a vehicle.

Hereinafter, the term “low frequency” refers to ultrasound in a low frequency band, that can be used to distinguish an object type and noise, and the term “high frequency” refers to ultrasound in a high frequency band, that can be used to distinguish an object type and noise.

Hereinafter, the term “high amplitude” is an amplitude higher than an amplitude threshold for distinguishing an object type and noise, and the term “low amplitude” is an amplitude lower than an amplitude threshold for distinguishing an object type and noise.

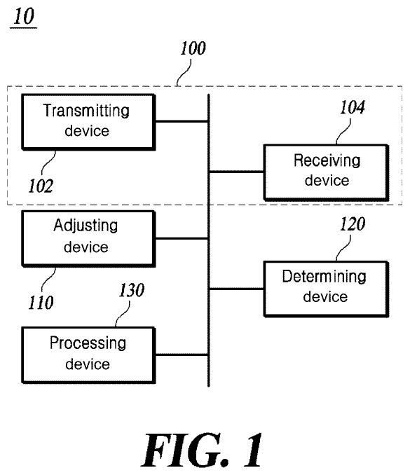

FIG. 1 is a block diagram schematically showing an object distinguishing apparatus according to an embodiment of the present disclosure.

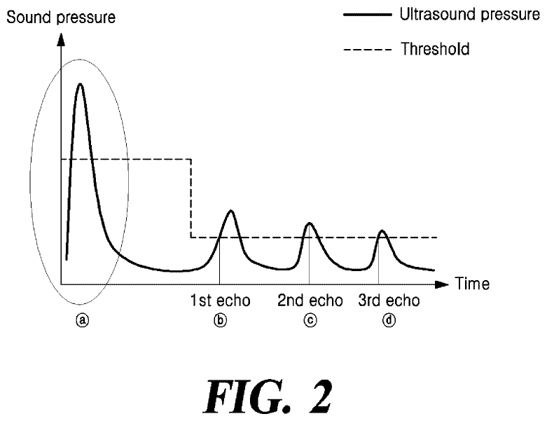

FIG. 2 is a view showing the sound pressure over time of transmit signals sent to or from an ultrasonic sensor according to an embodiment of the present disclosure.

An object distinguishing apparatus 10 according to an embodiment of the present disclosure may include all or some of an ultrasonic sensor 100, an adjusting device 110, a determining device 120, and a processing device 130. Not all of the blocks illustrated in FIG. 1 are essential components, and, in other embodiments, some blocks included in the object distinguishing apparatus 10 may be added, changed, or deleted. Meanwhile, the components illustrated in FIG. 1 show functionally distinct elements, and at least one element may be implemented in an integrated fashion in an actual physical environment.

Each of the above devices (e.g., the adjusting device 110, the determining device 120, and the processing device 130) may constitute modules and/or devices of the object distinguishing apparatus 10, which may be a controller. For example, the above devices of the object distinguishing apparatus 10 may constitute hardware controllers each having a processor and memory. The object distinguishing apparatus 10 may include one or more processors and memory.

The ultrasonic sensor 100 includes a transmitting device 102 for transmitting a signal and a receiving device 104 for receiving a received/reflected signal. Referring to FIG. 2, as indicated by the solid line which indicates ultrasound pressure, a first peak area represents an ultrasound pressure corresponding to a transmit signal \textcircled{a} transmitted by the transmitting device, and second, third, and fourth peak areas represent an ultrasound pressure corresponding to a reflected signal received by the receiving device. A 1st echo \textcircled{b} is a portion of the second peak area of the ultrasound pressure, which is higher than a preset threshold, and a 2nd echo \textcircled{c} is a portion of the third peak area of the ultrasound pressure, which is higher than the preset threshold, and a 3rd echo \textcircled{d} is a portion of the fourth peak area of the ultrasound pressure, which is higher than the preset threshold.

The ultrasonic sensor 100 is a device that recognizes an object by sending a signal and receiving the signal reflected back from the object. It may detect the presence, position, and speed of movement of an object.

The adjusting device 110 may adjust the direction of the ultrasonic sensor 100 so that a signal from the ultrasonic sensor 100 is directed toward an object. The adjusting device 110 may perform control according to a user's request, or may perform automatic control by means of an electronic control unit (ECU) provided in the vehicle.

The adjusting device 110 sets the ultrasonic sensor 100 to a low-frequency mode or a high-frequency mode. The low-frequency mode which uses low-frequency ultrasound, provides a wide beam angle, consumes a small amount of energy, and is advantageous for short-range measurement. The high-frequency mode, which uses high-frequency ultrasound, provides a narrow beam angle, consumes a large amount of energy, and is advantageous for long-range measurement.

The determining device 120 determines whether a recognized object corresponds to a first type object by using a received signal. Upon detecting \textcircled{1} a low frequency 1st echo having a high amplitude but no high frequency echo, upon detecting \textcircled{2} a low frequency 1st echo having a high amplitude and a high frequency 1st echo having a low amplitude, upon detecting \textcircled{3} a low frequency 1st echo having a low amplitude but no high frequency echo, or upon detecting \textcircled{4} a low frequency 1st echo having a low amplitude and a high frequency 1st echo having a low amplitude, the determining device 120 determines that the recognized object corresponds to the first type object.

The determining device 120 determines whether a recognized object corresponds to a second type object by using a received signal. Upon detecting \textcircled{1} a low frequency 1st echo having a high amplitude and a high frequency 1st echo having a high amplitude, upon detecting \textcircled{2} a low frequency 1st echo having a high amplitude and a high frequency 2nd echo having a high amplitude, upon detecting a \textcircled{3} low frequency 2nd echo having a high amplitude and a high frequency 1st echo having a high amplitude, or upon detecting \textcircled{4} a low frequency 2nd echo having a high amplitude and a high frequency 2nd echo having a high amplitude, the determining device 120 determines that the recognized object corresponds to the second type object.

The determining device 120 distinguishes whether a recognized object is taller or shorter than a reference height by using a received signal. Upon determining that the recognized object corresponds to a first type object, the determining device 120 distinguishes it as an object that is shorter than the reference height. Upon determining that the recognized object corresponds to a second type object, the determining device 120 distinguishes it as an object that is taller than the reference height.

The determining device 120 determines whether a received signal corresponds to noise. Upon detecting \textcircled{1} a low frequency 3rd echo having a high amplitude and a high frequency 2nd echo having a high amplitude, upon detecting \textcircled{2} a low frequency 3rd echo having a high amplitude and a high frequency 3rd echo having a high amplitude, upon detecting \textcircled{3} a low frequency 3rd echo having a high amplitude and a high frequency 2nd echo having a high amplitude, upon detecting \textcircled{4} a low frequency 3rd echo having a low amplitude and a high frequency 3rd echo having a high amplitude, or upon detecting \textcircled{5} a high frequency 3rd echo having a low amplitude, the determining device 120 determines that the received signal corresponds to noise.

The determining device 120 determines whether the vehicle can be parked in an available parking space by using height information of the object. As used herein, the “available parking space” is a space where the vehicle can be parked because there are no first type object and no second type object, and is also a space where the vehicle can be parked with one side's wheels over a curb even if there is a first type object.

The processing device 130 eliminates a received signal if it is deemed as noise. For example, upon detecting a low frequency 3rd echo having a high amplitude and a high frequency 2nd echo having a high amplitude, the determining device 120 determines that the recognized object is not a second type object but noise, even if it detects a low frequency 1 st echo having a high amplitude, and the processing device 130 eliminates the signal which is deemed as noise. As used herein, the “noise” includes a signal by which the recognized object is deemed as a second type object even if it is a first type object, a signal by which the recognized object is deemed as a first type object even if it is a second type object, and a signal by which the positions of the first type object and the second type object are determined wrongly.

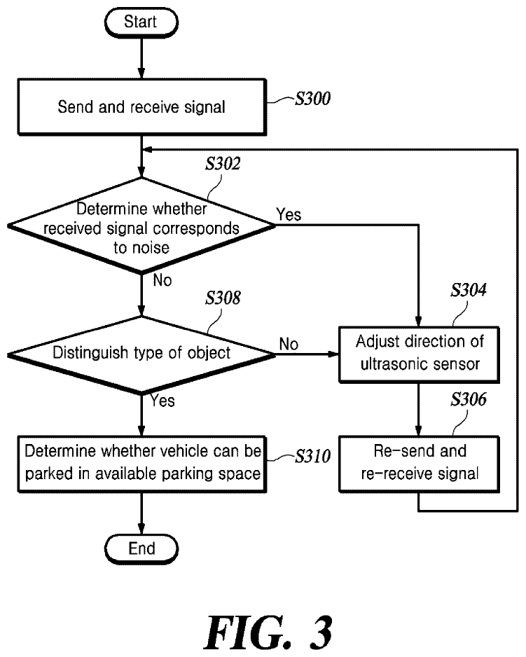

FIG. 3 is a flowchart schematically showing an operation of an object distinguishing apparatus 10 according to an embodiment of the present disclosure.

The object distinguishing apparatus 10 sends an ultrasonic signal and receives a signal reflected from an object (S300). The ultrasonic signal may be used in a low-frequency mode and a high-frequency mode. In the low-frequency mode, low-frequency ultrasound is used, and, in the high-frequency mode, high-frequency ultrasound is used. The lower the frequency of ultrasound, the wider the beam angle, the smaller the energy, and the more advantageous it is for short-range measurement.

The object distinguishing apparatus 10 determines whether the entire or part of a received signal corresponds to noise by using the received signal (S302). The object distinguishing apparatus 10 may determine whether a received signal corresponds to noise by using a low frequency 3rd echo and a high frequency 3rd echo. The object distinguishing apparatus 10 may determine whether a received signal corresponds to noise by using a low frequency 3rd echo and a high frequency 2nd echo. The object distinguishing apparatus 10 excludes a signal from signals for distinguishing the object if the signal is deemed as noise. As used herein, the “noise” includes a signal by which the recognized object is deemed as a second type object even if it is a first type object, a signal by which the recognized object is deemed as a first type object even if it is a second type object, and a signal by which the positions of the first type object and the second type object are determined wrongly.

If the received signal is deemed as noise, the object distinguishing apparatus 10 may adjust the direction of the ultrasonic sensor (S304). The object distinguishing apparatus 10 may adjust the direction of the ultrasonic sensor according to a user's request, or may perform automatic control by means of an ECU provided in the vehicle.

The object distinguishing apparatus 10 sends an ultrasonic signal in a changed direction and receives a signal reflected from the object (S306).

If the received signal is not deemed as noise, the object distinguishing apparatus 10 distinguishes the object based on the height of the object by using the received signal (S308). The object may be distinguished by using a low frequency 1st echo and a high frequency 1st echo. The object distinguishing apparatus 10 also may distinguish the object by determining the type of the object. For example, upon detecting a low frequency 1st echo having a low amplitude but no high frequency 1st echo, the object may be deemed as a first type object and therefore a short object. Upon detecting a low frequency 1st echo having a high amplitude and a high frequency 1st echo having a high amplitude, the object is deemed as a second type object and therefore a tall object.

The object distinguishing apparatus 10 may distinguish the object by using a low frequency 2nd echo and a high frequency 2nd echo. For example, upon detecting a low frequency 2nd echo having a high amplitude and a high frequency 2nd echo having a high amplitude, the object is deemed as a second type object and therefore a tall object.

The object distinguishing apparatus 10 may distinguish the object by using a low frequency 1st echo and a high frequency 2nd echo. The object distinguishing apparatus 10 may distinguish the object by using a high frequency 1st echo and a low frequency 2nd echo.

In a case where the object distinguishing apparatus 10 is not able to determine the type of the object or distinguish the object, even with the received signal, the direction of the ultrasonic sensor may be adjusted (S304). The object distinguishing apparatus 10 may adjust the direction of the ultrasonic sensor according to a user's request, or may perform automatic control by an ECU provided in the vehicle.

The object distinguishing apparatus 10 determines whether the vehicle can be parked in an available parking space by using height information of the object (S310). As used herein, the “available parking space” is a space where the vehicle can be parked because there are no first type object and no second type object, and is also a space where the vehicle can be parked with one side's wheels over a curb even if there is a first type object.

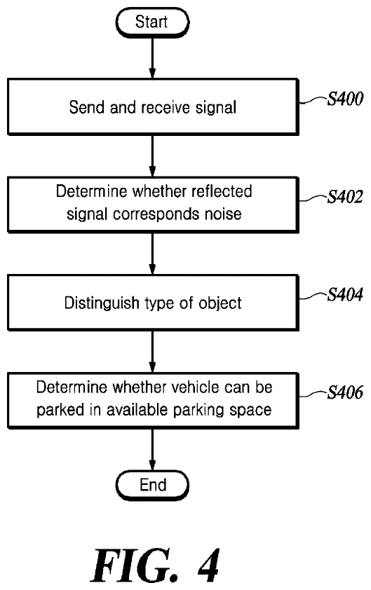

FIG. 4 is a flowchart for illustrating an object distinguishing method according to an embodiment of the present disclosure. The method depicted in FIG. 4 may be implemented by being executed by one or more physical computing devices (hereinafter, “object distinguishing system(s)”) including the object distinguishing apparatus 10. The following description will be made in terms of an operation performed by an object distinguishing system.

The object distinguishing system sends an ultrasonic signal and receives a signal reflected from an object (S400). The object distinguishing system may use an ultrasonic sensor by setting the ultrasonic signal to a low-frequency mode or a high-frequency mode.

The object distinguishing system determines whether the reflected signal corresponds to noise (S402). The object distinguishing system may determine whether the reflected signal corresponds to noise by using a low frequency 3rd echo and a high frequency 3rd echo. The object distinguishing system also may determine whether the reflected signal corresponds to noise by using a low frequency 3rd echo and a high frequency 2nd echo. The object distinguishing system excludes a signal from signals for distinguishing the object if the signal is deemed as noise.

If the received signal is deemed as noise, the object distinguishing system may adjust the direction of the ultrasonic sensor. If the type of the object cannot be determined by the received signal, the object distinguishing system may adjust the direction of the ultrasonic sensor. The object distinguishing system may adjust the direction of the ultrasonic sensor according to a user's request, or may perform automatic control by means of an ECU provided in the vehicle.

The object distinguishing system may distinguish the object based on the height by using the reflected signal (S404). It may distinguish the object by using a low frequency 1st echo and a high frequency 1st echo. The object distinguishing system may distinguish the object by determining the type of the object. The object distinguishing system also may distinguish the object by using a low frequency 2nd echo and a high frequency 2nd echo. The object distinguishing system also may distinguish the object by using a low frequency 1st echo and a high frequency 2nd echo. The object distinguishing system also may distinguish the object by using a high frequency 1st echo and a low frequency 2nd echo.

If the object distinguishing system is not able to determine the type of the object or distinguish the object by the received signal, it may adjust the direction of the ultrasonic sensor. The object distinguishing system may adjust the direction of the ultrasonic sensor according to a user's request, or may perform automatic control by means of an ECU provided in the vehicle.

The object distinguishing system determines whether the vehicle can be parked in an available parking space by using height information of the object (S406). As used herein, the “available parking space” is a space where the vehicle can be parked because there are no first type object and no second type object, and is also a space where the vehicle can be parked with one side's wheels over a curb even if there is a first type object.

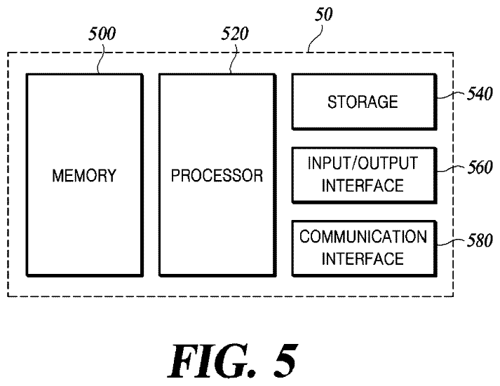

FIG. 5 is a block diagram schematically showing an exemplary computing device that can be used to implement a method according to the present disclosure.

The computing device 50 may include some or all of a memory 500, a processor 520, storage 540, an input/output interface 560, and a communication interface 580. The computing device 50 may structurally and/or functionally include at least part of the object distinguishing apparatus 10. The computing device 50 may be a stationary computing device such as a desktop computer, a server, and an AI accelerator, and also may be a portable computing device such as a laptop computer and a smartphone.

The memory 500 may store a program that causes the processor 520 to perform methods or operations according to various embodiments of the present disclosure. For example, the program may include a plurality of instructions executable by the processor 520, and the method depicted in FIG. 4 may be performed by executing a plurality of instructions by the processor 520.

The memory 500 may be a single memory or multiple memories. In this case, information needed to perform methods or operations according to various embodiments of the present disclosure may be stored in a single memory or divided among multiple memories. If the memory 500 includes multiple memories, the multiple memories may be physically separated.

The memory 500 may include at least one of volatile memory and non-volatile memory. The volatile memory includes SRAM (static random access memory) or DRAM (dynamic random access memory), and the nonvolatile memory includes flash memory or the like.

The processor 520 may include at least one core for executing at least one instruction. The processor 520 may execute the instructions stored in the memory 500. The processor 520 may be a single processor or multiple processors.

The storage 540 retains stored data even if the power supplied to the computing device 50 is interrupted. For example, the storage 540 may include non-volatile memory, and may include a storage medium such as a magnetic tape, an optical disc, and a magnetic disk.

A program stored in the storage 540 may be loaded onto the memory 500 before executed by the processor 520. The storage 540 may store a file written in a programming language, and a program created by a compiler or the like may be loaded from a file onto the memory 500. The storage 540 may store data that is to be processed by the processor 520 and/or data processed by the processor 520.

The input/output interface 560 may include an input device such as a keyboard and a mouse, and may include an output device such as a display device and a printer. The user may trigger the execution of a program by the processor 520 via the input/output interface and/or see processing results of the processor 520.

The communication interface 580 may provide access to an external network. For example, the computing device 50 may communicate with other devices over the communication interface 580.

Each element of the apparatus or method can be implemented in hardware or software, or a combination of hardware and software. The functions of the respective elements may be implemented in software, and a microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable recording medium includes any type of recording device that stores data that can be read by a computer system. Such a computer-readable recording medium may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium may also be distributed across a networked computer system, such that the computer-readable code is stored and executed in a distributed manner.

Although operations are illustrated in the flowcharts/timing charts in this specification as being sequentially performed, this is merely an exemplary description of the technical idea of one embodiment of the present disclosure. In other words, those having ordinary skill in the art to which the present disclosure pertains may appreciate that various modifications and changes can be made without departing from essential features of embodiments of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed present disclosure. Therefore, the embodiments of the present disclosure have been described for the sake of brevity and clarity. The scope of the technical idea of the present disclosure is not limited by the illustrations. Accordingly, one of ordinary skill in the art would understand that the scope of the claimed present disclosure is not to be limited by the above explicitly described embodiments but by the claims and equivalents thereof.

What is claimed is:

1. A method for distinguishing objects to assist in parking a vehicle, the method comprising:
setting, by a controller, an ultrasonic sensor to a low-frequency mode or a high-frequency mode;
sending, by an ultrasonic sensor, a signal and receiving a received signal that is reflected from an object;
determining, by the controller, whether the received signal contains noise;
distinguishing, by the controller, the object based on a height of the object by using the received signal; and
determining, by the controller, whether the vehicle can be parked by using the height of the object.

2. The method of claim 1, wherein the received signal contains at least one of a first echo, a second echo, and a third echo.

3. The method of claim 2, wherein distinguishing the object comprises distinguishing the object by determining that the object is either a first type object or a second type object.

4. The method of claim 3, wherein determining whether the vehicle can be parked comprises determining that the vehicle can be parked even if the first type object is present, if the vehicle can be parked with one side's wheels over the first type object.

5. The method of claim 2, wherein distinguishing the object comprises distinguishing the object by using a low frequency 1st echo and a high frequency 1st echo.

6. The method of claim 2, wherein distinguishing the object comprises distinguishing the object by using a low frequency 2nd echo and a high frequency 2nd echo.

7. The method of claim 2, wherein distinguishing the object comprises distinguishing the object by using a low frequency 1st echo and a high frequency 2nd echo.

8. The method of claim 2, wherein determining whether the received signal contains noise comprises determining whether the received signal corresponds to noise by using a low frequency 3rd echo and a high frequency 3rd echo.

9. The method of claim 2, wherein determining whether the received signal contains noise comprises determining whether the received signal corresponds to noise by using a low frequency 3rd echo and a high frequency 2nd echo.

10. The method of claim 1, further comprising adjusting the direction of the ultrasonic sensor.

11. The method of claim 1, further comprising excluding the received signal from signals for distinguishing the object if the received signal is deemed as noise.

12. An apparatus for distinguishing objects, the apparatus comprising:
at least one memory storing instructions; and
at least one processor,
wherein the at least one processor sets an ultrasonic sensor to a low-frequency mode or a high-frequency mode, sends a signal and receives a signal reflected from an object, by using the ultrasonic sensor, determines whether the received signal contains noise, distinguishes the object based on a height of the object by using the received signal, and determines whether the vehicle can be parked by using the height of the object.

13. The apparatus of claim 12, wherein the at least one processor receives a signal containing at least one of a first echo, a second echo, and a third echo.

14. The apparatus of claim 13, wherein the at least one processor distinguishes the object by determining that the object is either a first type object or a second type object.

15. The apparatus of claim 14, wherein the at least one processor determines that the vehicle can be parked even if the first type object is present, if the vehicle can be parked with one side's wheels over the first type object.

16. The apparatus of claim 12, wherein the at least one processor adjusts the direction of the ultrasonic sensor.

17. The apparatus of claim 12, wherein the at least one processor excludes the received signal from signals for distinguishing the object if the received signal is deemed as noise.

18. A vehicle comprising the apparatus of claim 12.

19. A non-transitory computer-readable recording medium containing program instructions executed by a processor, the computer readable medium comprising:
program instructions that send a signal and receive a received signal that is reflected from an object;
program instructions that determine whether the received signal contains noise;
program instructions that distinguish the object based on a height of the object by using the received signal; and
program instructions that determine whether the vehicle can be parked by using the height of the object.

20. The non-transitory computer readable recording medium of claim 19, wherein the received signal contains at least one of a first echo, a second echo, and a third echo, and the object is distinguished by determining that the object is either a first type object or a second type object.
